(19) United States
(12) Patent Application Publication
(10) Pub. No.: US 2013/0241796 A1
(43) Pub. Date: Sep. 19, 2013

(54) ANTENNA DEVICE

(71) Applicant: MURATA MANUFACTURING CO., LTD., Kyoto (JP)

(72) Inventor: Shoji NAGUMO, Kyoto (JP)

(73) Assignee: MURATA MANUFACTURING CO., LTD., Kyoto (JP)

(21) Appl. No.: 13/886,007

(22) Filed: May 2, 2013

Related U.S. Application Data
(63) Continuation of application No. PCT/JP2011/069684, filed on Aug. 31, 2011.

(30) Foreign Application Priority Data
Nov. 18, 2010 (JP) 2010-257911
Nov. 18, 2010 (JP) 2010-257912

(51) Int. Cl. H01Q 1/50

(52) U.S. Cl. CPC H01Q 1/50
USPC 343/861

(57) ABSTRACT

An antenna device can detect the surrounding environment and appropriately corrected and maintain stable antenna characteristics. The antenna device includes at least first and second antenna element electrodes, an antenna matching circuit provided along a wireless communication signal path for the first antenna element electrode, a capacitance detection circuit connected to the second antenna element electrode and operable to detect stray capacitance of the antenna element electrode using a sensing signal. A matching control circuit controls the antenna matching circuit in accordance with an output signal of the capacitance detection circuit.

### CROSS REFERENCE TO RELATED APPLICATIONS

The present application is a continuation of International Application No. PCT/2011/069684 filed on Aug. 31, 2011, and claims priority to Japanese Patent Application No. 2010-257911 filed on Nov. 18, 2010, and Japanese Patent Application No. 2010-257912 filed on Nov. 18, 2010, the entire contents of each of these applications being incorporated herein by reference in their entirety.

### TECHNICAL FIELD

The technical field relates to antenna devices included in apparatuses such as portable terminals.

### BACKGROUND

In U.S. Patent Application Publication No. 2009/0046030 (Patent Document) 1, International Publication No. 2009/033510 (Patent Document 2), and U.S. Patent Application Publication No. 2004/0217909 (Patent Document 3), technologies are disclosed for sensing the surrounding conditions in order to correct, using feedback, antenna characteristics that are changed by the nearness of a human body.

Patent Document 1 discloses a technology in which the input impedance of an antenna (return loss, VSWR), which varies with changes in the surrounding conditions, is directly measured. A directional coupler is installed along a line between an RF circuit and the antenna, and the electrical power in a direction from the RF circuit toward the antenna (input direction) and in a direction from the antenna toward the RF circuit (reflection direction) is monitored in order to know the input impedance in the current state.

Patent Document 2 discloses a technology in which the change in the amount of electromagnetic wave radiated from an antenna is directly measured. The change in an electric field radiated from the antenna due to the influence of the surroundings is detected by using a sensor such as a Hall element. The part of this change caused by a change in input impedance and the part of this change caused by an increase in loss due to absorption of radiated electromagnetic waves by a nearby medium cannot be separated, and the change in radiated electric field is detected as a combined result.

Patent Document 3 discloses a technology in which the distance to a nearby human body is measured. The distance is measured by means of light reflected by a nearby body by using a light-emitting/receiving element.

Here, the configuration of an antenna device described in Patent Document 2 will be described on the basis of FIG. 1.

The antenna device includes an antenna 18, a high-frequency circuit 6 that inputs a wireless high-frequency signal to the antenna 18, a first matching circuit 4 formed of a number of network elements and provided along a signal line between the antenna 18 and the high-frequency circuit 6, a controller 8, and a detector 10 that detects an electromagnetic field radiated by the antenna 18. The controller 8 performs matching control on the antenna 18 on the basis of a detected electric field.

### SUMMARY

The present disclosure provides an antenna device that can detect the surrounding environment, which causes the antenna characteristics to change, and that can appropriately correct the antenna characteristics, thereby maintaining antenna characteristics that are always stable.

An antenna device according to the present disclosure includes a plurality of antenna element electrodes including at least a first antenna element electrode and a second antenna element electrode, an antenna matching circuit provided along a wireless communication signal path for the first antenna element electrode, a capacitance detection circuit that is connected to the second antenna element electrode and detects a stray capacitance of that antenna element electrode using a sensing signal, and a matching control circuit that controls the antenna matching circuit in accordance with an output signal of the capacitance detection circuit.

In a more specific embodiment, the capacitance detection circuit may be a capacitance-voltage conversion amplifier circuit that includes a feedback capacitance in a feedback circuit of an inverting amplifier circuit and outputs a voltage that is substantially proportional to a rate of change ratio of a detection target capacitance to the feedback capacitance.

Another more specific embodiment may include a reactance element (e.g., a capacitor) that hinders inflow of a sensing signal (e.g., exhibits a high impedance in sensing frequency band) and is provided along a wireless communication signal path, which is a transmission path for the second antenna element electrode.

In yet another more specific embodiment, the antenna device may include a reactance element (e.g., an inductor) that hinders looping back of a wireless communication signal fed to the second antenna element electrode or transmitted from the second antenna element electrode and is provided along a sensing signal path, which is a transmission path between the second antenna element electrode and the capacitance detection circuit.

In still another more specific embodiment, among a plurality of types of antenna element electrodes that are capable of being connected to an antenna connection portion of the antenna matching circuit, the first antenna element electrode is an antenna element electrode that has a good radiation Q (i.e., low Q value) in an integrated body that includes the antenna element electrode.

In another more specific embodiment, a selection condition for the above plurality of types of antenna element electrodes may be any of a position of a feeding point for the antenna element electrode, a gap between the antenna element electrode and an opposing ground, and the size of the antenna element electrode, or any combination thereof.

Another antenna device according the present disclosure includes a plurality of antenna element electrodes that are all fed by a feeder circuit, a capacitance detection circuit that is connected to the plurality of antenna element electrodes and detects a stray capacitance of each of the antenna element electrodes using a sensing signal, and a nearby body state detector configured to detect a state of nearness of a nearby body with respect to the plurality of antenna element electrodes on the basis of a detection signal of the capacitance detection circuit.

In a more specific embodiment of the above antenna device including a plurality of antenna element electrodes that are all fed by a feeder circuit, the antenna device may further include an antenna matching circuit provided along a wireless communication signal path for the plurality of antenna element electrodes, and a matching control circuit that controls the antenna matching circuit in accordance with an output signal of the capacitance detection circuit.

In another more specific embodiment of the above antenna device including a plurality of antenna element electrodes that are all fed by a feeder circuit, the antenna device may further include a reactance element that hinders inflow of a sensing signal is provided along a wireless communication signal path, which is a transmission path for the plurality of antenna element electrodes.

In another more specific embodiment of the above antenna device including a plurality of antenna element electrodes that are all fed by a feeder circuit, the antenna device may further include a reactance element that hinders looping back of a wireless communication signal fed to the plurality of antenna element electrodes or transmitted from the plurality of antenna element electrodes is provided along a sensing signal path, which is a transmission path between the plurality of antenna element electrodes and the capacitance detection circuit.

In another more specific embodiment of the above antenna device including a plurality of antenna element electrodes that are all fed by a feeder circuit, among a plurality of types of antenna element electrodes that are capable of being connected to an antenna connection portion of the antenna matching circuit, the plurality of antenna element electrodes are antenna element electrodes that have a good radiation Q (i.e., low Q value) in integrated bodies including the antenna element electrodes.

In a further specific embodiment of the above antenna device including a plurality of antenna element electrodes that are all fed by a feeder circuit, selection conditions for the plurality of types of antenna element electrodes may include a position of a feeding point for the antenna element, and a position of connection of the capacitance detection circuit to the antenna element electrode.

In any of the above embodiments, the sensing signal may be a signal having a frequency that is sufficiently lower than, that is 1/1000 or less, the resonant frequency of the plurality of antenna element electrodes.

### BRIEF DESCRIPTION OF DRAWINGS

FIG. 1 illustrates the configuration of an antenna device described in Patent Document 2.

FIG. 2 illustrates the configuration of an antenna device of a first exemplary embodiment.

FIG. 3(A) schematically illustrates with lines of electric force an electric field generated between a first antenna element electrode 21 and a substrate ground electrode 50. FIG. 3(B) schematically illustrates with lines of electric force an electric field generated between a second antenna element electrode 22 and the substrate ground electrode 50. FIG. 3(C) illustrates a state in which part of a human body has come near to the antenna device.

FIG. 4(A) is a circuit diagram of a capacitance detection circuit and FIG. 4(B) is a waveform diagram illustrating operation of the capacitance detection circuit.

FIG. 5 illustrates a capacitance-voltage conversion circuit that is different from the circuit illustrated in FIG. 4.

FIG. 6(A) is a circuit diagram of a capacitance detection circuit based on the circuit illustrated in FIG. 5. FIG. 6(B) is a waveform diagram illustrating operation of the capacitance detection circuit.

FIG. 7 illustrates operations of a capacitance detection circuit 60, a matching control circuit 70 and a variable matching circuit 31.

FIG. 8 illustrates the configuration of an antenna device of a second exemplary embodiment.

FIG. 9 illustrates the configuration of an antenna device of a third exemplary embodiment.

FIG. 10 illustrates the configuration of an antenna device of a fourth exemplary embodiment.

FIG. 11 illustrates the configuration of an antenna device of a fifth exemplary embodiment.

FIG. 12(A) schematically illustrates with lines of electric force an electric field formed between antenna element electrodes 21R and 21L, and a substrate ground electrode 51 for an antenna device of a sixth exemplary embodiment. FIG. 12(B) illustrates a state in which a state in which part of a human body has come near to the antenna device.

FIG. 13 illustrates the configuration of an antenna device according to a sixth example that includes capacitance detection circuits 60R and 60L that detect stray capacitances linked to antenna element electrodes 21R and 21L or changes in the stray capacitances.

FIG. 14(A) illustrates a state in which a portable terminal 101 is being held while a call is being made. FIG. 14(B) illustrates a state in which the portable terminal 101 is in a vertical orientation and is being operated while being held away from the operator's head. FIG. 14(C) illustrates a state in which the portable terminal 101 is being held in a horizontal orientation with the right hand.

FIG. 15(A) illustrates a state in which the portable terminal 101 is being held in the right hand while a call is being made, and FIG. 15(B) illustrates a state in which the portable terminal 101 has been placed on a desk D.

FIG. 16 illustrates a state in which a certain operation is being performed on the portable terminal 101.

FIG. 17(A), FIG. 17(B), FIG. 17(C) and FIG. 17(D) illustrate a number of example configurations for the position of a substrate inside a cellular phone terminal of a seventh exemplary embodiment, and the positional relationship between the substrate and antenna elements.

FIG. 18 illustrates the configuration of an antenna device according to an eighth exemplary embodiment.

FIG. 19 illustrates the configuration of an antenna device of a ninth exemplary embodiment.

FIG. 20 illustrates the configuration of an antenna device of a tenth exemplary embodiment.

FIG. 21 illustrates the configuration of an antenna device of an eleventh exemplary embodiment.

FIG. 22 illustrates the configuration of an antenna device to be compared and contrasted with the antenna device illustrated in FIG. 13.

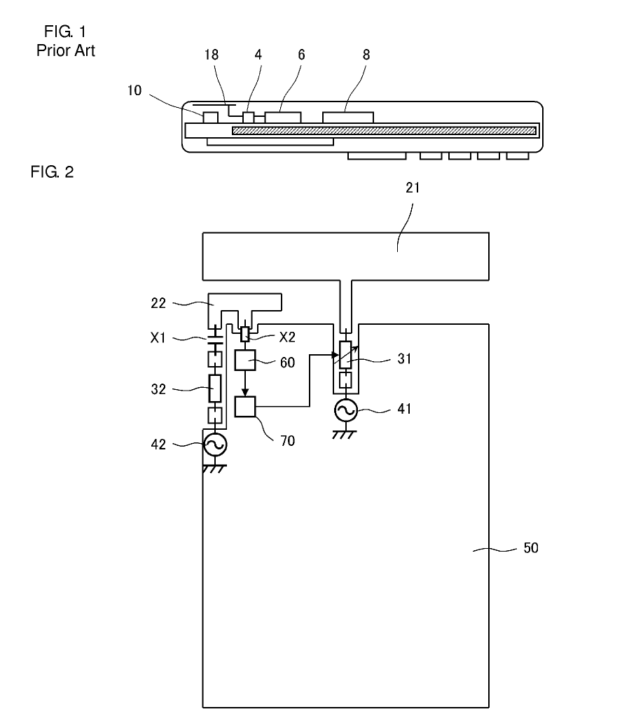

### DETAILED DESCRIPTION

The inventor realized that in the antenna device disclosed in Patent Document 1, it is necessary to supply electrical power to the antenna in order to know the input impedance and only changes in impedance in the transmission frequency band can be known. In reality, it is desirable to know not a result of changes in input impedance at specific frequencies but “what state an antenna resonant system is in due to external influences.”

In the antenna device disclosed in Patent Document 2, there is a fear that the antenna characteristics are degraded due to provision of a member that is unrelated to radiation. In addition, even from the viewpoint of integration of the antenna and sensor, in a structure in which the antenna and the sensor exist as separate bodies combined in a simple manner and one of them is contained in the space occupied by the other, nearby components have an adverse effect on the antenna characteristics.

Utilization of reflection of light, infrared rays, sound waves, and so forth, as in the antenna device disclosed in Patent Document 3, results in the detection direction and angle being limited, as these waves have a poor diffractive property (high linearity). Consequently, this technology is not sufficient to detect nearness of a human body or the like in all directions from a terminal. Alternatively, a plurality of distance measurement sensors would be necessary.

Therefore, despite sensing the surrounding conditions in order to stabilize the antenna characteristics, it cannot be said that any of the above-described configurations is preferable.

In addition, in each of Patent Documents 1 to 3, the means for detecting the nearness of a human body or the like is used solely for this purpose. Consequently, it cannot necessarily be said that effective use is made of the means for detecting nearness of a human body or the like.

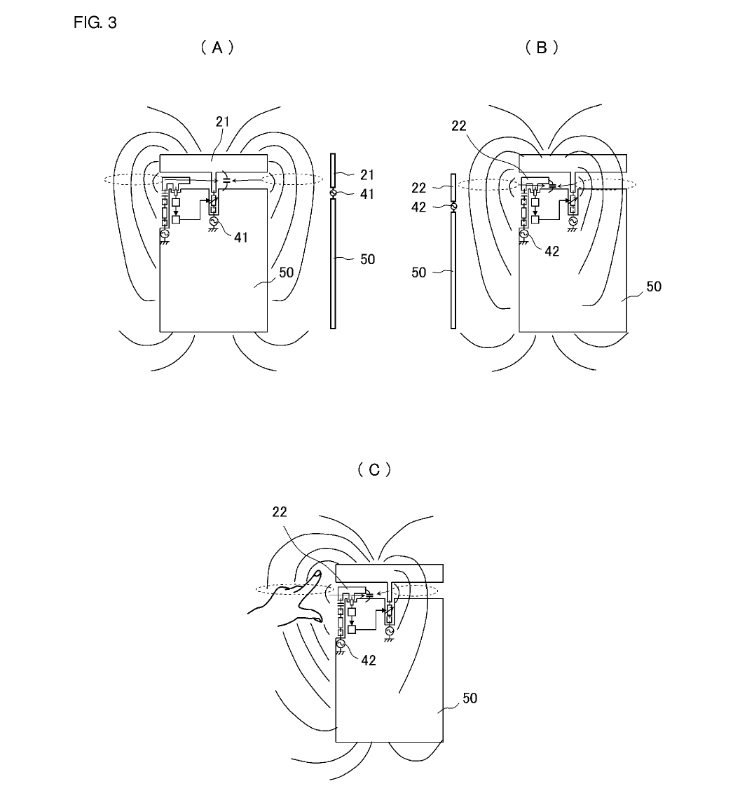

An antenna device according to a first exemplary embodiment that can address the above shortcomings will now be described with reference to FIGS. 2 to 7.

FIG. 2 illustrates the configuration of the antenna device of the first embodiment. This antenna device includes a substrate on which a ground electrode 50 has been formed, and a first antenna element electrode 21 and a second antenna element electrode 22. A variable matching circuit 31 is provided between the first antenna element electrode 21 and a feeder circuit 41. A reactance element X1 and a matching circuit 32 are provided between the second antenna element electrode 22 and a feeder circuit 42. In addition, a reactance element X2, a capacitance detection circuit 60 and a matching control circuit 70 are provided between the second antenna element electrode 22 and the variable matching circuit 31.

The reactance element X1 is for example a capacitor and hinders flow of a sensing signal toward the matching circuit 32 and the feeder circuit 42 (exhibits a high impedance in the sensing frequency band). In addition, the reactance element X2 is for example an inductor and hinders looping back of a wireless communication signal fed to the second antenna element electrode 22 or transmitted from the second antenna element electrode 22.

A transmission path between the second antenna element electrode 22 and the feeder circuit 42 is a wireless communication signal path. In addition, a signal path from the second antenna element electrode 22 to the capacitance detection circuit 60 is a sensing signal path.

The first antenna element electrode 21 is used as a main (cellular) antenna of a cellular phone terminal. The second antenna element electrode 22 is used as a Bluetooth (Registered Trademark) or wireless LAN antenna.

In FIG. 2, the capacitance detection circuit 60 is formed of a capacitance-voltage conversion circuit (C-V conversion circuit) and converts a change in stray capacitance generated by the nearness of a human body or the like into a change in voltage and outputs the change in voltage. The variable matching circuit 31 is a reconfigurable matching circuit that performs matching for two frequency bands, that is, a low band and a high band.

FIG. 3(A) schematically illustrates with lines of electric force an electric field generated between the first antenna element electrode 21 and the substrate ground electrode 50. In addition, FIG. 3(B) schematically illustrates with lines of electric force an electric field generated between the second antenna element electrode 22 and the substrate ground electrode 50. An electric field is formed between each of the antenna element electrodes and the substrate ground electrode 50. The electric field alternates at a high frequency as in a wireless communication signal and as a result electromagnetic waves are radiated to the outside. An electrostatic field is formed by a direct current.

In the right-hand side of FIG. 3(A), a pseudo-dipole formed by the first antenna element electrode 21 and the ground electrode 50 is illustrated. In addition, in the left-hand side of FIG. 3(B), a pseudo-dipole formed by the second antenna element electrode 22 and the ground electrode 50 is illustrated.

The first and second antenna element electrodes 21 and 22 and the substrate ground electrode 50 may be regarded as the opposing conductors of capacitors connected by lines of electric force and the capacitances of these capacitors are so-called stray capacitances that determine the resonant frequency.

FIG. 3(C) illustrates a state in which part of a human body has come near to the antenna device. When part of a human body (palm or finger) has entered the electric field in this way, (since a human body is a dielectric having a high resistivity) the lines of electric force are drawn toward and become incident (terminate) on the human body and increase between the second antenna element electrode 22 and the ground electrode 50. Equivalently, this is a state in which a dielectric has been inserted between capacitor electrodes. Thus, the stray capacitance between the second antenna element electrode 22 and the ground electrode 50 increases. Similarly, the stray capacitance between the first antenna element electrode 21 and the ground electrode 50 also increases. Thus, there is a close relationship between the degree of nearness of a human body and the change in stray capacitance.

The antenna device according to the first embodiment, in addition to transmitting and receiving electromagnetic waves of wireless communication signals through the first antenna element electrode 21, the second antenna element electrode 22 and the ground electrode 50, maintains appropriate matching even when the stray capacitances change due to the nearness of a nearby body. The capacitance detection circuit 60 illustrated in FIG. 2 detects a stray capacitance by using the second antenna element electrode 22. The matching control circuit 70 controls the variable matching circuit 31 in accordance with an output signal of the capacitance detection circuit 60. Thus, matching between the first antenna element electrode 21 and the feeder circuit 41 is always properly maintained.

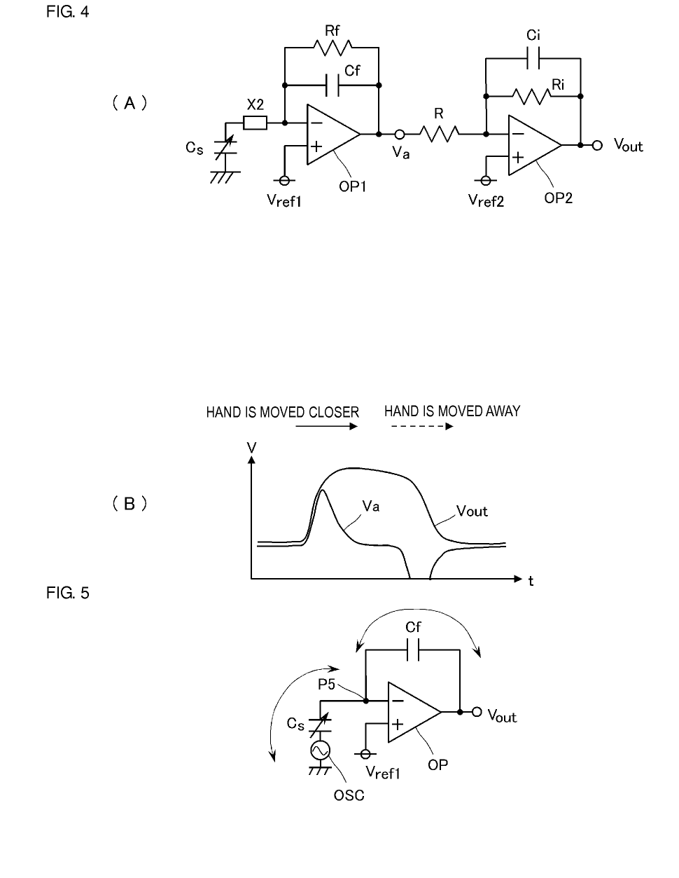

Next, a specific example of the capacitance detection circuit 60 will be described. FIG. 4(A) is a circuit diagram of a capacitance detection circuit and FIG. 4(B) is a waveform diagram illustrating operation of the capacitance detection circuit.

The capacitance detection circuit 60 employs an operational amplifier in order to extract an output signal as a voltage signal and amplify the signal. The capacitance-voltage conversion circuit is formed of an inverting amplifier circuit formed of an operational amplifier OP1 and a detection target capacitance Cs and a feedback capacitance Cf. A reference potential Vref1 is applied to a non-inverting input terminal of the operational amplifier OP1. The reactance element X2, which is connected to an inverting input terminal of the operational amplifier OP1, corresponds to the reactance element X2 in FIG. 2. The reactance element X2 hinders looping back of a wireless communication signal fed to the second antenna element electrode 22 or transmitted from the second antenna element electrode 22, and therefore need not necessarily be provided in the input section of the capacitance detection circuit. It is sufficient that the reactance element X2 be provided midway along the sensing signal path between the second antenna element electrode 22 and the capacitance detection circuit 60.

The operational principle of this capacitance-voltage conversion circuit is that a voltage (V=Q/C) that changes with input or output of charge to or from Cs and Cf due to a change in the capacitance of the detection target capacitance Cs is amplified.

Since operation is unstable in a feedback circuit including only Cs and Cf, a resistance Rf is connected in parallel with the feedback capacitance Cf. The resistance Rf is also a factor that determines a cut-off frequency, that is, is also a factor that determines the speed (=time constant) of the input and output of charge to and from Cs and Cf. If we consider a time response for “a change in capacitance due to nearness of a human body,” which is the phenomenon to be handled, and how long this state is held, this resistance Rf needs to have a very large value.

For this capacitance detection circuit, it is assumed that there is no alternating current signal source such as an oscillator. Accordingly, an integration circuit, which includes an operational amplifier, is provided downstream of the Cs-Cf feedback circuit. That is, the integration circuit is formed of an inverting amplifier circuit including an operational amplifier OP2, a feedback circuit including a capacitor Ci, and a resistance R. In addition, a resistance Ri is connected in parallel with the capacitor Ci to set an integration time constant. A reference potential Vref2 is applied to a non-inverting input terminal of the operational amplifier OP2.

As illustrated in FIG. 4(B), when the distance to the hand changes, an output voltage Va of the capacitance-voltage conversion circuit is substantially proportional to the rate of change of the capacitance C that is target of detection. In addition, since an output voltage Vout of the integration circuit is obtained by integrating the voltage Va, the voltage Vout changes in accordance with the distance to the nearby hand.

With this capacitance detection circuit, there is no need for a signal source such as an oscillator and as a result the capacitance detection circuit can be simplified. In addition, there is an advantage because there is no signal source that would be a source of noise.

FIG. 5 illustrates another capacitance-voltage conversion circuit. This capacitance-voltage conversion circuit employs an alternating current signal source.

An oscillator OSC is connected in series with the detection target capacitance Cs. A reference potential Vref1 is applied to a non-inverting input terminal of an operational amplifier OP. Accordingly, the potential (input voltage of operational amplifier OP) of a connection point P5 between the detection target capacitance Cs and the feedback capacitance Cf stably corresponds to the detection target capacitance. Compared to the frequency band of a wireless communication signal, the oscillation frequency of the oscillator OSC is a low frequency that is almost equal to that of a direct current signal.

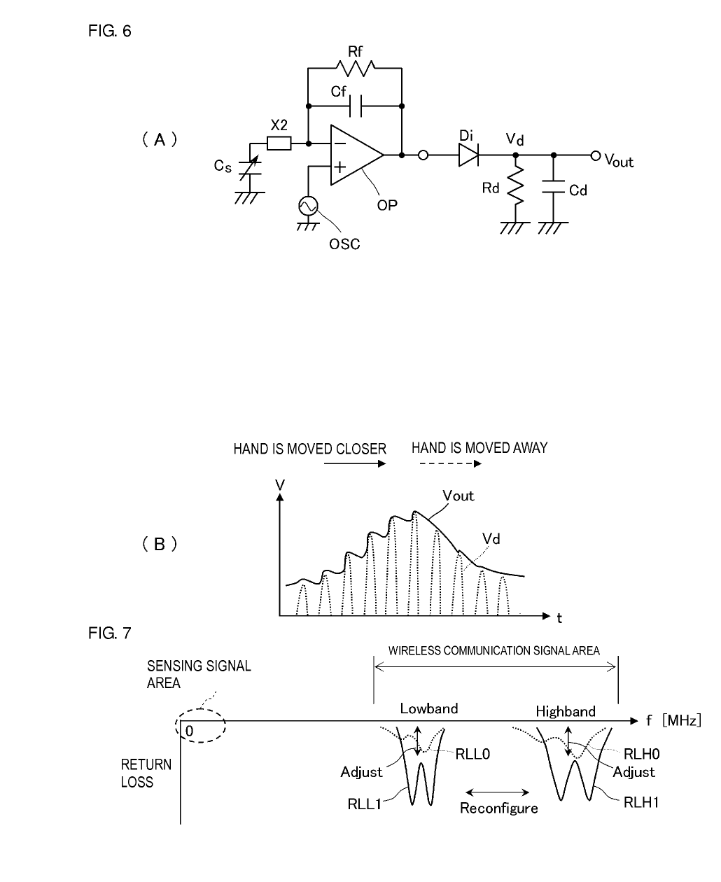

FIG. 6(A) is a circuit diagram of a capacitance detection circuit based on the circuit illustrated in FIG. 5. FIG. 6(B) is waveform diagram for the circuit illustrated in FIG. 6(A).

In the example of FIG. 6(A), the oscillator OSC is connected to a non-inverting input terminal of the operational amplifier. In addition, a resistance Rf is connected in parallel with the feedback capacitance Cf. A detection circuit including a diode D1, a capacitor Cd and a resistance Rd is provided at the output of the operational amplifier OP and is configured to extract an envelope as an output.

As illustrated in FIG. 6(B), when the hand moves closer, the amplitude of the voltage Vd increases with the increasing value of the detection target capacitance Cs. Therefore, the output voltage Vout of the detection circuit increases. When the hand moves away, the amplitude of the voltage Vd decreases with the decreasing value of the detection target capacitance Cs and the output voltage Vout decreases.

In addition, a circuit that is input with an alternating current signal from an alternating current signal source and extracts a signal as an alternating current output signal of the capacitance detection circuit is not limited to those illustrated in FIG. 5 and FIG. 6. In addition, the circuit is not limited to one in which the output signal is extracted as an alternating current voltage signal, and therefore any of a variety of circuits can also be accordingly used as the detection circuit.

In addition, other than the detection circuit, a low-pass filter that blocks an alternating current component may be provided.

Moreover, the location of the alternating current signal source is not limited to those illustrated in FIG. 5 and FIG. 6. In addition, even if a separate oscillator OSC is not provided, part of a high-frequency circuit section may serve as an alternating current signal source. That is, some kind of alternating current signal may be extracted from a high-frequency circuit.

FIG. 7 illustrates operations of the capacitance detection circuit 60, the matching control circuit 70 and the variable matching circuit 31. In FIG. 7, the horizontal axis represents frequency and the vertical axis represents return loss. In this example, in an antenna device that performs communication in either of two frequency bands that are a low band and a high band, a low-frequency signal having a frequency of zero (electrostatic field) or a frequency of nearly zero is used to detect a stray capacitance.

The sensing signal has a frequency that is sufficiently lower than (on the order of equal to or less than 1/1000) the resonant frequency of the plurality of antenna element electrodes and is almost a direct current.

When a human body comes near to the antenna device and the stray capacitance changes (increases), antenna matching for the low band and the high band attempts to enter a non-matched state (return loss is degraded). However, the capacitance detection circuit 60 outputs a voltage corresponding to the increase in the stray capacitance and the matching control circuit 70 supplies a control voltage corresponding to the increase in the stray capacitance to the variable matching circuit 31. Thus, the circuit constant of the variable matching circuit 31 is changed and the variable matching circuit 31 returns the non-matched state to an appropriate matching state (appropriate matching state is maintained).

In FIG. 7, a low-band return loss waveform RLL0 is adjusted to become a return loss waveform RLL1 through appropriate matching, and similarly a high-band return loss waveform RLH0 is adjusted to become a return loss waveform RLH1 through appropriate matching.

The low band is for example the 800 MHz/900 MHz band of the global system for mobile communication (GSM) (registered trademark) and the high band is for example a band of the digital communication system (DCS), the personal communication services (PCS), and the universal mobile telecommunication system (UMTS).

With the first embodiment, the following effects are obtained.

(1) A matching state can be controlled in accordance with the surrounding conditions and therefore, a variable matching circuit can be optimally configured and the antenna efficiency can be maximized.

(2) The space occupied by a conductor plate used for stray capacitance detection doubles as a space used for the antenna of another system and therefore space is saved.

(3) Because a conductor for stray capacitance detection is not specially provided, such a conductor for stray capacitance detection does not adversely affect the antenna element electrodes.

(4) Since the stray capacitance of the antenna resonant system is known, the stray capacitance can be detected without there being any restrictions on the communication frequencies.

(5) Since the electric field extends over the entirety of the antenna resonant system and stray capacitance that occurs as a result of this is made a target of detection, detection can be performed in all directions from a portable terminal.

These effects are also achieved by the following embodiments.

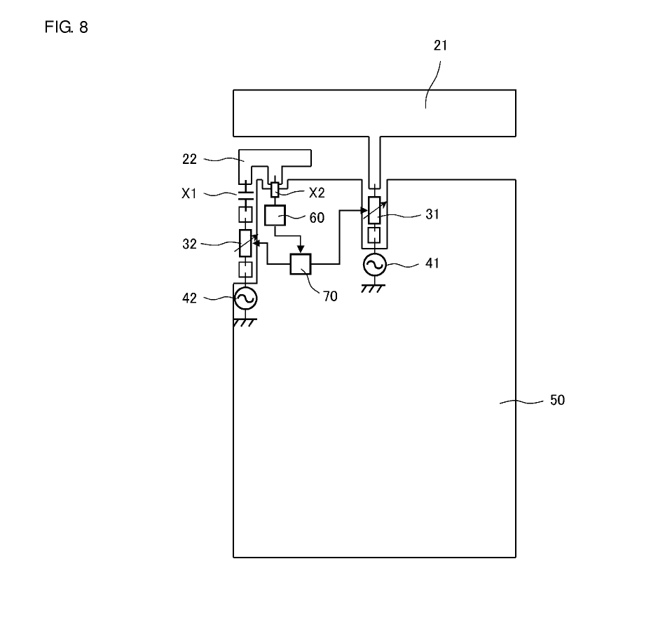

FIG. 8 illustrates the configuration of an antenna device of a second exemplary embodiment. This antenna device includes a substrate on which a ground electrode 50 has been formed, and a first antenna element electrode 21 and a second antenna element electrode 22. A variable matching circuit 31 is provided between the first antenna element electrode 21 and a feeder circuit 41. A reactance element X1 and a matching circuit 32 are provided between the second antenna element electrode 22 and a feeder circuit 42. In addition, a reactance element X2, a capacitance detection circuit 60 and a matching control circuit 70 are provided between the second antenna element electrode 22 and the variable matching circuit 31.

The reactance element X1 hinders flow of a sensing signal toward the variable matching circuit 32 and the feeder circuit 42 (exhibits a high impedance in the sensing frequency band). In addition, the reactance element X2 hinders looping back of a wireless communication signal fed to the second antenna element electrode 22 or transmitted from the second antenna element electrode 22.

A transmission path between the second antenna element electrode 22 and the feeder circuit 42 is a wireless communication signal path. In addition, a signal path from the second antenna element electrode 22 to the capacitance detection circuit 60 is a sensing signal path.

In the second embodiment, the matching circuit 32 provided along the wireless communication signal path to the second antenna element electrode 22 is also a variable matching circuit. Thus, an appropriate matching state corresponding to changes in stray capacitance due to the nearness of a human body or the like is maintained for the second antenna.

According to the second embodiment, the matching for two antennas is corrected by using information on one stray capacitance and therefore the number of capacitance detection circuits and the number of matching control circuits are small. Consequently, cost reduction and space saving are achieved.

In addition, three or more antennas may be targets of matching correction.

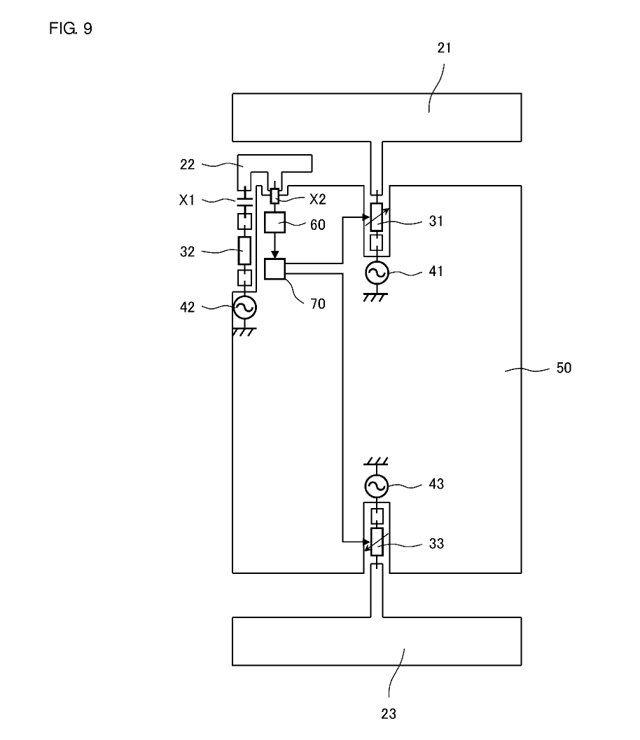

FIG. 9 illustrates the configuration of an antenna device of a third exemplary embodiment. This antenna device includes a substrate on which a ground electrode 50 has been formed, and a first antenna element electrode 21, a second antenna element electrode 22 and a third antenna element electrode 23. A variable matching circuit 31 is provided between the first antenna element electrode 21 and a feeder circuit 41. A reactance element X1 and a matching circuit 32 are provided between the second antenna element electrode 22 and a feeder circuit 42. A variable matching circuit 33 is provided between the third antenna element electrode 23 and a feeder circuit 43. In addition, a reactance element X2, a capacitance detection circuit 60 and a matching control circuit 70 are provided between the second antenna element electrode 22 and the variable matching circuits 31 and 33.

The reactance element X1 hinders flow of a sensing signal toward the variable matching circuit 32 and the feeder circuit 42 (exhibits a high impedance in the sensing frequency band). In addition, the reactance element X2 hinders looping back of a wireless communication signal fed to the second antenna element electrode 22 or transmitted from the second antenna element electrode 22.

The first antenna element electrode 21 and the third antenna element electrode 23 are used as dual-system antennas in for example an MIMO (multiple-input and multiple-output) system.

According to this configuration, in accordance with a stray capacitance detected using the second antenna element electrode 22, an appropriate matching state is maintained in correspondence with changes in the stray capacitance due to the nearness of a human body or the like for not only the first antenna formed of the first antenna element electrode 21 but also for a third antenna formed of the third antenna element electrode 23.

According to the third embodiment, the matching for two antennas is corrected by using information on one stray capacitance and therefore the number of capacitance detection circuits and the number of matching control circuits are small. Consequently, cost reduction and space saving are achieved.

In addition, three or more antennas may be targets of matching correction.

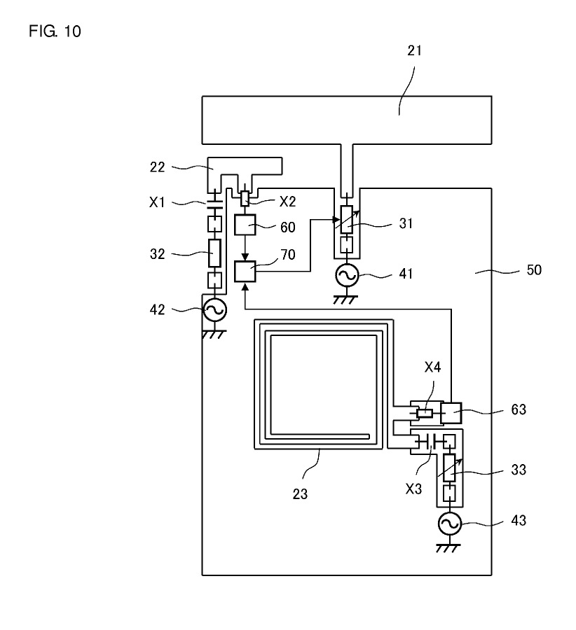

FIG. 10 illustrates the configuration of an antenna device of a fourth exemplary embodiment. This antenna device includes a substrate on which a ground electrode 50 has been formed, and a first antenna element electrode 21, a second antenna element electrode 22 and a third antenna element electrode 23. A variable matching circuit 31 is provided between the first antenna element electrode 21 and a feeder circuit 41. A reactance element X1 and a matching circuit 32 are provided between the second antenna element electrode 22 and a feeder circuit 42. A reactance element X3 and a matching circuit 33 are provided between the third antenna element 23 and a feeder circuit 43. The third antenna element electrode 23 is, for example, an antenna coil for near field communication (NFR).

This antenna device includes a single matching control circuit 70 and a reactance element X2 and a capacitance detection circuit 60 are provided between the matching control circuit 70 and the second antenna element electrode 22. In addition, a reactance element X4 and a capacitance detection circuit 63 are provided between the matching control circuit 70 and the third antenna element electrode 23.

The matching control circuit 70 controls the variable matching circuit 31 on the basis of output signals of the capacitance detection circuits 60 and 63.

With this configuration, an appropriate matching state is maintained for an antenna formed of the first antenna element electrode in accordance with the state of nearness of a nearby body detected by means of stray capacitances of two antenna element electrodes that are at positions separated from each other.

According to the fourth embodiment, two antenna element electrodes are used to detect stray capacitances and therefore the precision of the stray capacitance detection information can be increased.

In addition, three or more antenna element electrodes may be used for stray capacitance detection.

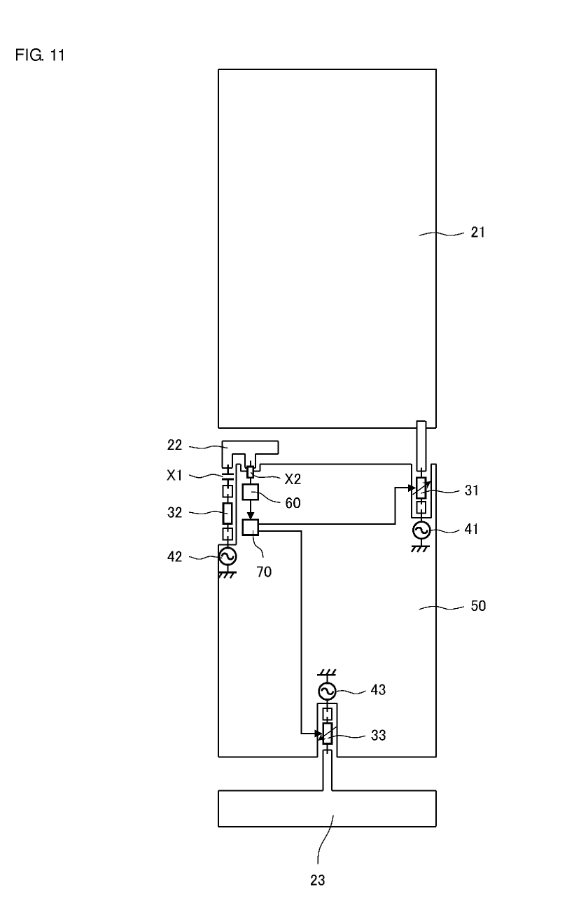

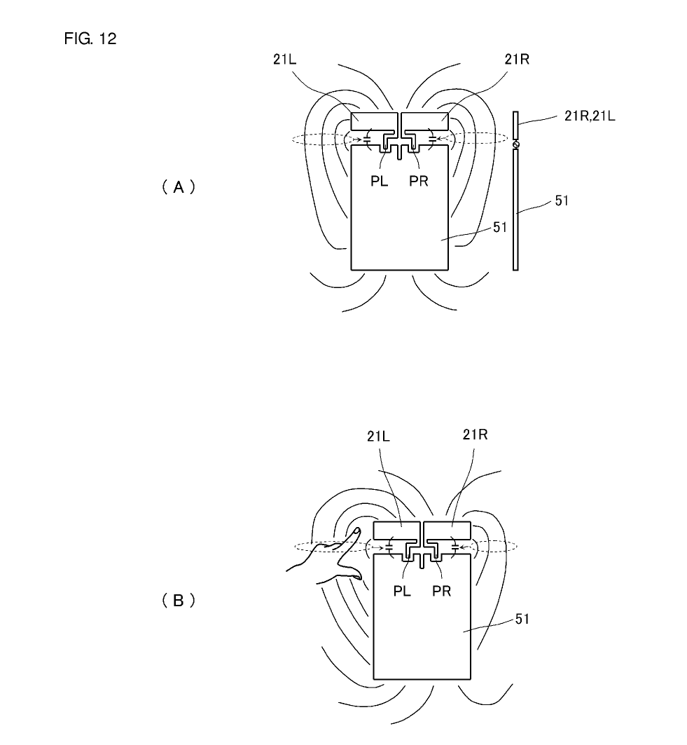

FIG. 11 illustrates a configuration of an antenna device of a fifth exemplary embodiment. This antenna device includes a substrate on which a ground electrode 50 has been formed, and a first antenna element electrode 21, a second antenna element electrode 22 and a third antenna element electrode 23. This antenna device differs from that of the third embodiment illustrated in FIG. 9 in terms of the structure of the first antenna element electrode 21. The first antenna element electrode 21 is one radiation electrode of a dipole antenna. That is, a casing dipole antenna is formed of the first antenna element electrode 21 and the ground electrode 50.

An antenna device according to a sixth exemplary embodiment will be described with reference to FIGS. 12 to 16.

An electric field is formed between the antenna element electrode 21 and the substrate ground electrode 51 as schematically illustrated by lines of electric force in FIG. 12(A). The electric field alternates at a high frequency as in a wireless communication signal and as a result electromagnetic waves are radiated to the outside. An electrostatic field is formed by a direct current.

On the right-hand side of FIG. 12(A), formation of a pseudo-dipole by the antenna element electrodes 21R and 21L and the substrate ground electrode 51 is illustrated.

The antenna element electrodes 21R and 21L and the substrate ground electrode 51 can be regarded as the opposing conductors of capacitors connected by lines of electric force and the capacitances of these capacitors are so-called stray capacitances that determine the resonant frequency.

FIG. 12(B) illustrates a state in which part of a human body has come close to the antenna device. When part of a human body (e.g., palm or finger) enters the electric field in this way, (since a human body is a dielectric having a high resistivity) the lines of electric force are drawn toward and become incident (i.e., terminate) on the human body and increase between the antenna element electrode 21L on the left-hand side and the substrate ground electrode 51. Equivalently, this is a state in which a dielectric has been inserted between capacitor electrodes. Consequently, the stray capacitance between the left-hand antenna element electrode 21L and the substrate ground electrode 51 increases. The stray capacitance between the right-hand antenna element electrode 21R and the substrate ground electrode 51 may also increase, but the stray capacitance between the left-hand antenna element electrode 21L and the substrate ground electrode 51 increases by a larger amount. Thus, there is a close relationship between the degree of nearness of a human body and the change in stray capacitance.

The present disclosure is characterized in that, as well as being configured to transmit and receive electromagnetic waves of wireless communication signals, the antenna element is also configured to be capable of detecting the directivity of a nearby body such as a human body and the manner of nearness of the nearby body with respect to the antenna element.

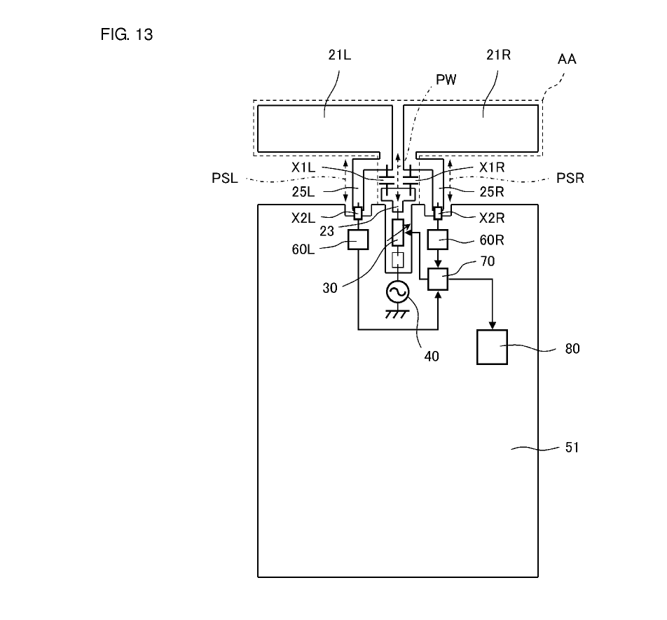

FIG. 13 illustrates the configuration of an antenna device that includes capacitance detection circuits 60R and 60L that detect stray capacitances linked to the antenna element electrodes 21R and 21L or changes in the stray capacitances.

An antenna element is formed of the two antenna element electrodes 21R and 21L, which are bilaterally symmetrical with each other. Extracted electrodes 25R and 25L respectively are extracted from the antenna element electrodes 21R and 21L. Reactance elements X1R and X1L are provided that hinder the flow of a sensing signal between the extracted electrodes 25R and 25L and a common electrode 23 (exhibit a high impedance in the sensing frequency band) These reactance elements X1R and X1L are for example capacitors. A transmission path between the antenna element electrodes 21R and 21L and a feeder circuit 40 is a wireless communication signal path. A variable matching circuit 30 is provided between the common electrode 23 and the feeder circuit 40. The antenna element electrodes 21R and 21L are simultaneously fed via the wireless communication signal path. Consequently, the space in which the antenna element electrodes 21R and 21L are provided serves as a single antenna area AA.

Signal paths from the antenna element electrodes 21R and 21L to the capacitance detection circuits 60R and 60L via the extracted electrodes 25R and 25L are sensing signal paths.

In addition, reactance elements X2R and X2L, which hinder looping back of a wireless communication signal fed to the antenna element electrodes 21R and 21L or transmitted from the antenna element electrodes 21R and 21L, are provided along the sensing signal paths between the antenna element electrodes 21R and 21L and the capacitance detection circuits 60R and 60L. These reactance elements X2R and X2L are, for example, inductors.

In FIG. 13, the capacitance detection circuits 60R and 60L are each formed of a capacitance-voltage conversion circuit (C-V conversion circuit) and convert a change in stray capacitance generated by the nearness of a human body or the like into a change in voltage and output the change in voltage. The variable matching circuit 30 is a reconfigurable matching circuit that performs matching for two frequency bands, that is, a low band and a high band.

The matching control circuit 70 supplies a control signal to the variable matching circuit 30 on the basis of output signals of the two capacitance detection circuits 60R and 60L. More specifically, for example, in the case where the two capacitance detection circuits 60R and 60L each generate a voltage signal corresponding to the magnitude of a stray capacitance, signals formed from the output voltages of the capacitance detection circuits 60R and 60L are supplied to the variable matching circuit 30. In accordance with a signal received from the matching control circuit 70, the variable matching circuit 30 determines a matching-circuit circuit constant such that optimal matching is performed for both of the two frequency bands of a low band and a high band in a state where the stray capacitances exist.

The matching control circuit 70 supplies output signals of the two capacitance detection circuits 60R and 60L to nearby body information processing means 80. The nearby body information processing means 80 detects the directivity of a nearby body and the manner of nearness of the nearby body with respect to the antenna element electrodes 21R and 21L in accordance with a signal from the matching control circuit 70 and performs certain processing in accordance therewith. The nearby distance of the nearby body to the antenna element electrodes 21R and 21L is detected on the basis of the value of the sum of the voltages of the output signals of the two capacitance detection circuits 60R and 60L and the degree of unbalance of nearness of the nearby body in terms of a left-right direction is detected on the basis of the difference in voltage between the output signals of the capacitance detection circuits 60R and 60L. Information in a plurality of dimensions is detected such as the directivity of a nearby body and the manner of nearness of the nearby body with respect to the antenna element, as will be described later, and appropriate processing is performed.

The specific configuration and principle of the capacitance detection circuits 60R and 60L are the same as that in the first embodiment illustrated in FIG. 4.

Next, an example of detection of the directivity of a nearby body and manner of nearness of the nearby body on the basis of output signals of the two capacitance detection circuits 60R and 60L will be described.

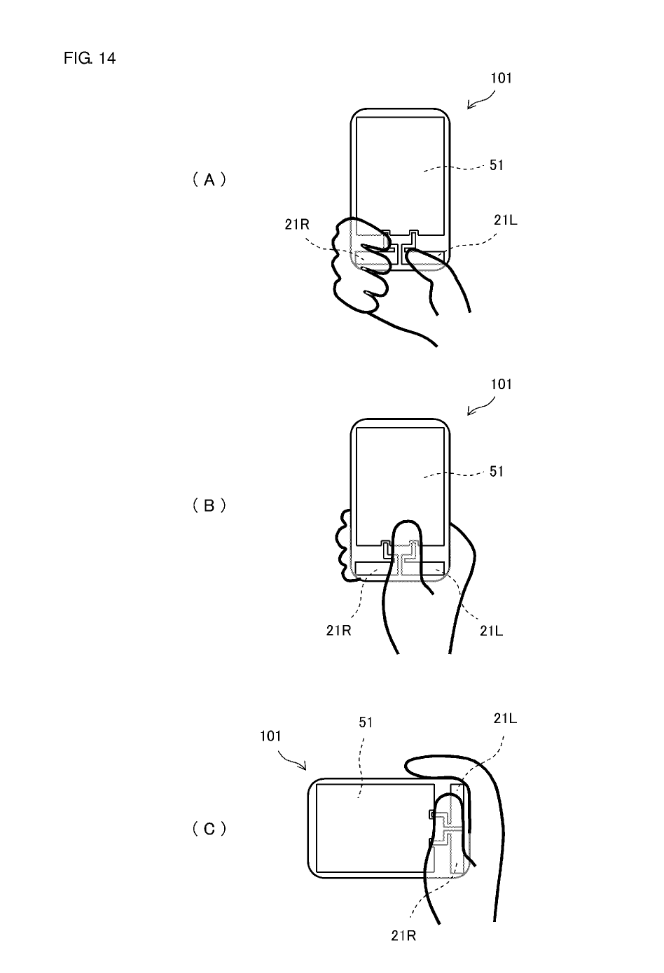

FIG. 14(A) illustrates a state in which a portable terminal 101 is being held while a call is being made. FIG. 14(B) illustrates a state in which the portable terminal 101 is in a vertical orientation and is being operated while being held away from the operator's head. FIG. 14(C) illustrates a state in which the portable terminal 101 is being held in a horizontal orientation with the right hand.

When a call is being made, as illustrated in FIG. 14(A), the portable terminal 101 is held at the bottom in a vertical orientation with one hand and therefore the state of nearness of a finger or palm with respect to the two antenna element electrodes 21R and 21L is different in the case where the portable terminal 101 is being held with the right hand and in the case where the portable terminal 101 is being held with the left hand. Consequently, it can be determined whether the holding hand is the left hand or the right hand.

The state of nearness of a finger or palm with respect to the two antenna element electrodes 21R and 21L differs depending on whether the portable terminal 101 is held in a horizontal orientation or a vertical orientation as illustrated in FIG. 14(B) and FIG. 14(C). Thus, the orientation of the portable terminal 101 can be determined without using a gyro sensor or the like. In addition, the state of nearness of a finger or palm with respect to the two antenna element electrodes 21R and 21L also differs in accordance with whether the left or right hand is holding the portable terminal 101 while it is being operated and therefore from this whether the portable terminal 101 is being held with the left or right hand can be determined.

The nearby body information processing means 80 illustrated in FIG. 13 makes a decision regarding operation of the portable terminal in accordance with the way in which the portable terminal 101 is being held by the operator. For example, if a call is being made as illustrated in FIG. 14(A), power is saved by reducing the brightness of the display and the display state is changed in accordance with the different orientations as in FIG. 14(B) and FIG. 14(C).

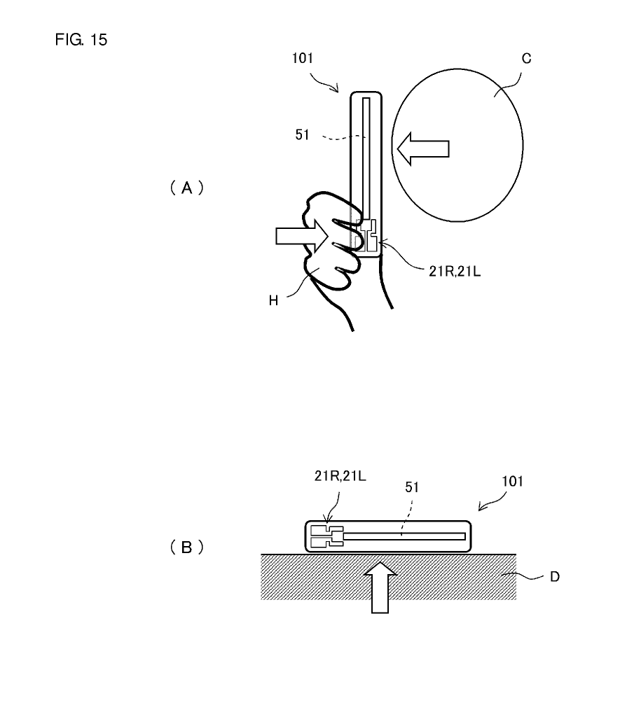

FIG. 15(A) illustrates a state in which the portable terminal 101 is being held in the right hand while a call is being made, and FIG. 15(B) illustrates a state in which the portable terminal 101 has been placed on a desk D. When a call is being made, some sort of operation is performed to start the call and then the portable terminal 101 is held against the ear, and therefore the stray capacitances formed with the two antenna element electrodes 21R and 21L change during this series of operations. Similarly, when the portable terminal 101 is placed on a desk, the stray capacitances formed with the two antenna element electrodes 21R and 21L change from immediately before to after being placed. Movement of the portable terminal 101 can be detected by detecting these changes in capacitance.

The nearby body information processing means 80 illustrated in FIG. 13 can also be used for the purpose of optimizing transmission power when a call is being made with the portable terminal held against the ear as in FIG. 15(A) and when the portable terminal has been placed on a desk as illustrated in FIG. 15(B).

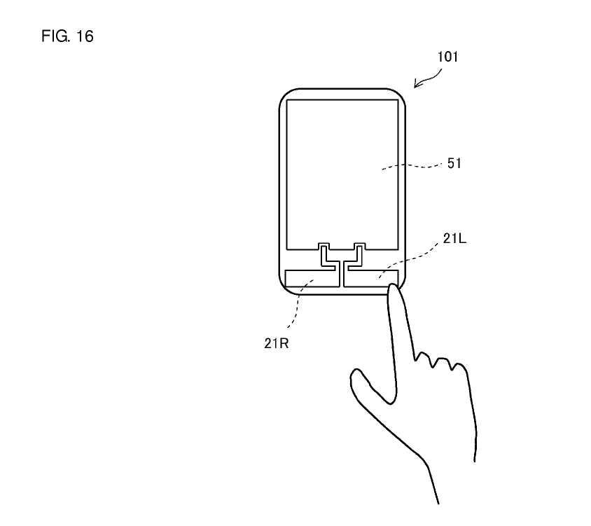

FIG. 16 illustrates a state in which a certain operation is being performed on the portable terminal 101. When the tip of a finger touches or comes near to the bottom right corner of the portable terminal 101, the stray capacitance of the one antenna element electrode 21L among the two antenna element electrodes 21R and 21L becomes relatively large. The nearby body information processing means 80 illustrated in FIG. 13 detects this change in capacitance and, for example, can also be used in the user interface such as in control of on/off of power supply when, for example, two successive touches such as a tap tap touch is made.

In a seventh exemplary embodiment, some examples of the position of a substrate inside a portable terminal and a positional relationship between the substrate and an antenna element will be described.

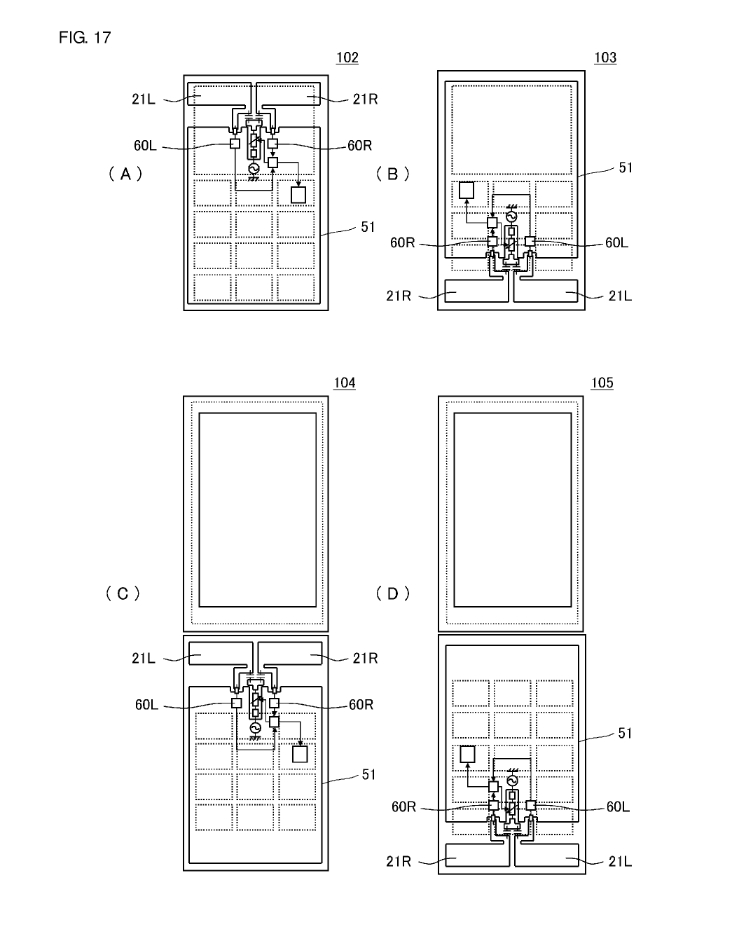

In the examples illustrated in FIG. 17(A) and FIG. 17(B), similarly to as described in the first embodiment, the substrate ground electrode 51, the capacitance detection circuits 60R and 60L and the antenna element electrodes 21R and 21L are provided in any single casing.

In the examples illustrated in FIG. 17(C) and FIG. 17(D), the substrate ground electrode 51, the capacitance detection electrodes 60R and 60L and the antenna element electrodes 21R and 21L are provided inside one casing of clam shell type casing.

In the examples illustrated in FIG. 17(A) and FIG. 17(C), the antenna element electrodes 21R and 21L are provided in a portion above the substrate ground electrode 51.

In the examples illustrated in FIG. 17(B) and FIG. 17(D), the antenna element electrodes 21R and 21L are provided in a portion below the substrate ground electrode 51.

In addition, other than the clam shell type casing, embodiments consistent with the disclosure can also be similarly applied to sliding and swivel type portable terminals.

According to the above-described embodiments, for example, a capacitance-voltage conversion circuit may be added as an additional component to the antenna structure substantially without any modification of the antenna structure. The affect on the design of the structure of a portable terminal is small and the antenna structure can be easily adopted in a plurality of models.

In addition, the wireless communication signal path and the sensing signal path can coexist as paths connected to the same antenna element. That is, the effect of loading of the capacitance-voltage conversion circuit on the characteristics on the wireless communication signal side (for example, matching characteristics) can be reduced and the effect of the inverse case can also be reduced.

In addition, in a matching state that varies with the surrounding conditions, a variable matching circuit can be appropriately configured and antenna efficiency can be maximized.

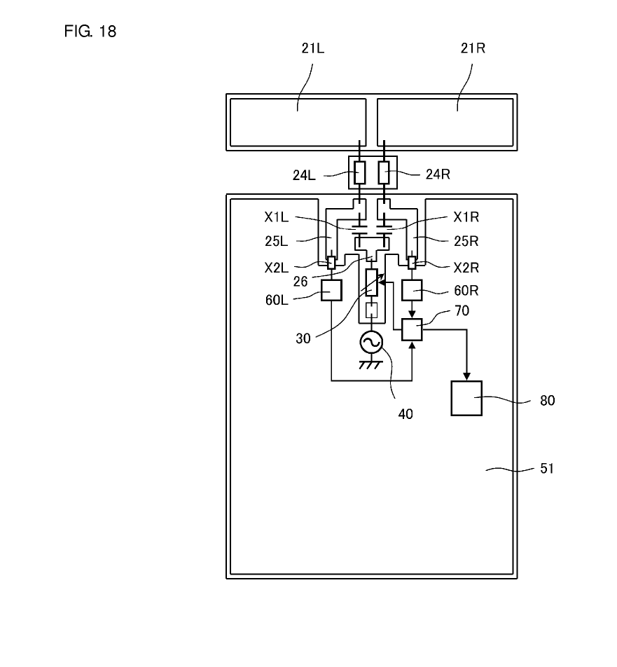

FIG. 18 illustrates the configuration of an antenna device according to an eighth exemplary embodiment.

In the example illustrated in FIG. 18, extracted electrodes 25R and 25L, which branch a wireless communication signal path and a sensing signal path, are formed of electrode patterns on the substrate. In addition, transmission lines 24R and 24L, which connect the substrate and the antenna element electrodes 21R and 21L, are provided.

Thus, branching of the wireless communication signal path and the sensing signal path is not limited to being between the antenna element electrodes and the substrate, and may also be on either of the antenna element side and the substrate side.

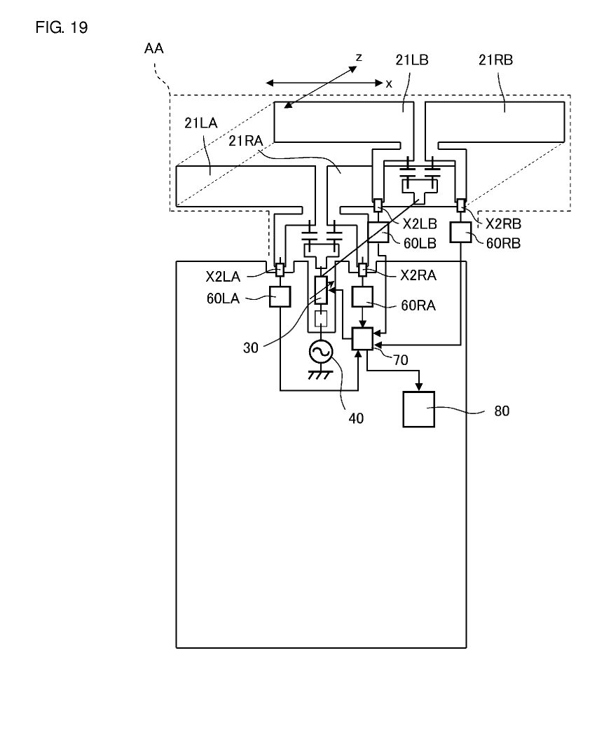

FIG. 19 illustrates the configuration of an antenna device of a ninth exemplary embodiment. This antenna device is obtained by adding another set of antennas to the antenna device of the sixth embodiment illustrated in FIG. 13. The configurations of the antenna element electrodes 21RA and 21LA, the capacitance detection circuits 60RA and 60LA, the reactance elements X2RA and X2LA, the variable matching circuit 30 and the feeder circuit 40 in FIG. 19 are the same as those illustrated in FIG. 13. In the ninth embodiment, antenna element electrodes 21RB and 21LB, capacitance detection circuits 60RB and 60LB, and reactance elements X2RB and X2LB are additionally provided. The antenna element electrodes 21RA, 21LA, 21RB, and 21LB are simultaneously fed via the wireless communication signal path. Consequently, the space in which the antenna element electrodes 21RA, 21LA, 21RB, and 21LB are provided serves as a single antenna area AA.

The matching control circuit 70 supplies a control signal to the variable matching circuit 30 on the basis of voltages output from the capacitance detection circuits 60RA, 60LA, 60RB, and 60LB. The matching control circuit 70 detects the degree of balance/unbalance between the magnitudes of the stray capacitances with respect to the left-right direction (x-axis direction) on the basis of detection signals of the capacitance detection circuits 60RA and 60LA and/or on the basis of detection signals of the capacitance detection signals 60RB and 60LB. In addition, the matching control circuit 70 detects the degree of balance/unbalance between the stray capacitances with respect to the thickness direction (z-axis direction) on the basis of detection signals of the capacitance detection circuits 60RA and 60RB and/or on the basis of detection signals of the capacitance detection circuits 60LA and 60LB. In this way, the state of nearness of a nearby body can be detected in the two dimensions of the left-right direction and the thickness direction.

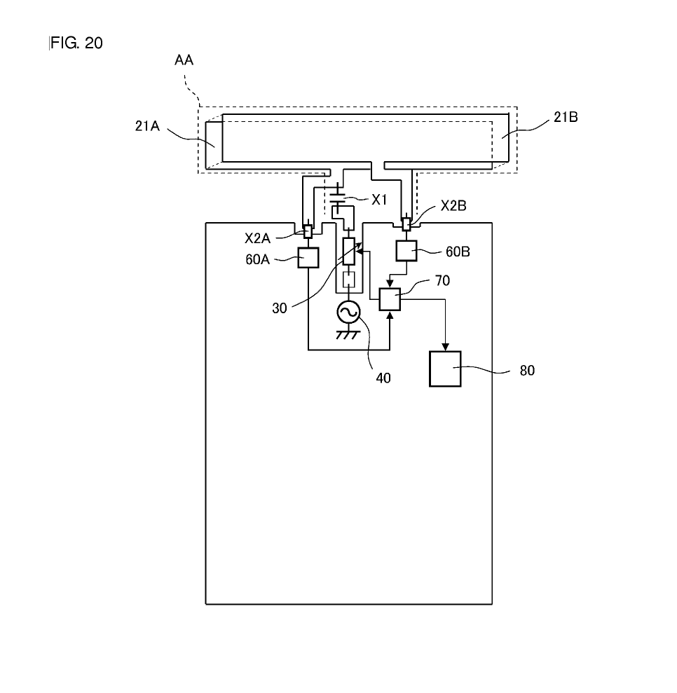

FIG. 20 illustrates a configuration of an antenna device of a tenth exemplary embodiment. In this antenna device, two antenna element electrodes are arranged at different positions in the thickness direction. In this example, antenna element electrodes 21A and 21B, capacitance detection circuits 60A and 60B, reactance elements X2A and X2B, a variable matching circuit 30, a feeder circuit 40 and a matching control circuit 70 are provided. The antenna element electrode 21A serves as both a radiation electrode and a capacitance detection electrode. The antenna element electrode 21B is provided so as to be a dedicated capacitance detection electrode.

The antenna element electrodes 21A and 21B serve as integrated radiation element as a result of being closely coupled with each other. Here, the antenna element electrode 21B may serve as a passive element with respect to the antenna element electrode 21A. Consequently, the space in which the antenna element electrodes 21A and 21B are provided serves as a single antenna area AA.

The matching control circuit 70 detects the degree of balance/unbalance between the stray capacitances with respect to the thickness direction on the basis of detection signals of the two capacitance detection circuits 60A and 60B. Thus, the state of nearness of a nearby body can be detected with respect to the thickness direction.

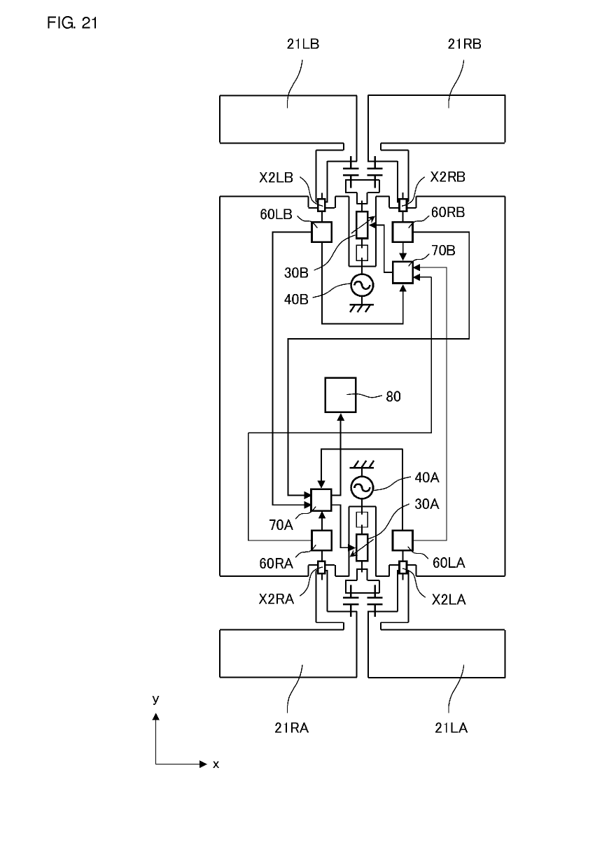

FIG. 21 illustrates the configuration of an antenna device of an eleventh exemplary embodiment. This antenna device includes two of the antenna devices of the sixth embodiment illustrated in FIG. 13. The configurations of the antenna element electrodes 21RA, 21LA, 21RB, and 21LB, the capacitance detection circuits 60RA, 60LA, 60RB, and 60LB, the reactance elements X2RA, X2LA, X2RB, and X2LB, the variable matching circuits 30A and 30B and the feeder circuits 40A and 40B in FIG. 21 are the same as those illustrated in FIG. 13. In the eleventh embodiment, the matching control circuit 70A supplies a control signal to the variable matching circuit 30A on the basis of voltages output from the capacitance detection circuits 60RA, 60LA, 60RB and 60LB and the matching control circuit 70B supplies a control signal to the variable matching circuit 30B on the basis of voltages output from the capacitance detection circuits 60RA, 60LA, 60RB, and 60LB. Each of the matching control circuits 70A and 70B detects the degree of balance/unbalance between the magnitudes of the stray capacitances with respect to the left-right direction (x-axis direction) on the basis of detection signals of the capacitance detection circuits 60RA and 60LA and/or on the basis of detection signals of the capacitance detection signals 60RB and 60LB. In addition, each of the matching control circuits 70A and 70B detects the degree of balance/unbalance between the stray capacitances with respect to the up-down direction (y-axis direction) on the basis of detection signals of the capacitance detection circuits 60RA and 60RB and/or on the basis of detection signals of the capacitance detection circuits 60LA and 60LB. In this way, the state of nearness of a nearby body can be detected with respect to the two dimensions of the left-right direction (x-axis direction) and the up-down direction (y-axis direction).

In a twelfth exemplary embodiment, selection of an antenna having a good radiation Q will be described.

In short, the efficiency of an antenna device consistent with the present disclosure depends on the radiation Q of an integrated body including the antenna element electrode that is to be the target of variable matching (antenna acting as a pseudo dipole including an antenna element electrode and a ground electrode that contributes to radiation). However, the antenna element electrode integrated body includes a load reactance that determines a resonant frequency in a desired frequency band. In addition, a capacitance detection circuit is loaded.

As the antenna element electrode, an antenna element electrode having the best possible radiation Q (small Q value) should be selected. Thus, the antenna efficiency and the frequency band width can be maximized under a condition of the structural space being restricted.

Here, “selection” includes of course investigating the origin of the radiation Q of the antenna and includes taking care so that the arrangement of the sensing signal path does not adversely affect the radiation Q of the antenna.

In the twelfth embodiment, this effect is experimentally investigated.

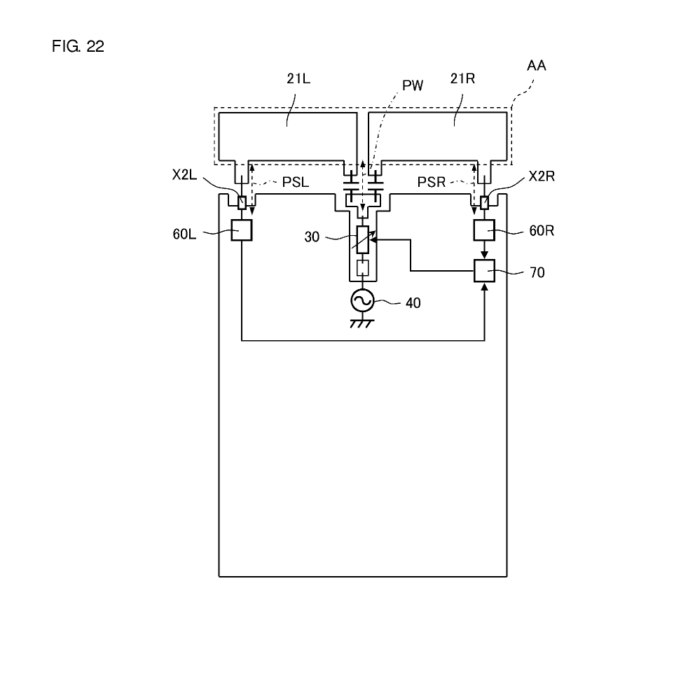

FIG. 22 illustrates the configuration of an antenna device to be compared and contrasted with the antenna device illustrated in FIG. 13. In the example illustrated in FIG. 22, sensing signal paths PSR and PSL are arranged at positions that are widely spaced apart from a wireless communication signal path PW.

In the arrangement illustrated in FIG. 22, the capacitance detection circuits 60R and 60L are inhibitors that are arranged in front of radiation to the outside. In a pseudo-dipole structure in which the radiation Q has been optimally set, it is preferable that a configuration be adopted in which the sensing signal paths PSR and PSL are substantially integrated with the wireless communication signal path (that is, a configuration in which the wireless communication signal path PW and the sensing signal paths PSR and PSL branch away from each other midway along their lengths) or that a configuration be adopted in which the wireless communication signal path PW and the sensing signal paths PSR and PSL are close to each other to such a degree that they can be regarded as being substantially one body when compared to wavelength.

In order to experimentally investigate the above-described effect, an antenna device to be compared and contrasted with the antenna device having the structure illustrated in FIG. 2 was prepared. In the antenna device for comparison and contrast, the extracted position (i.e., position of connection of the variable matching circuit 31) of the first antenna element electrode 21 of the antenna device illustrated in FIG. 2 is arranged in the vicinity of the right edge so as to be greatly shifted from the center.

For the antenna formed of the first antenna element electrode of the antenna device for comparison and contrast, the radiation Q of the antenna in the high band is poor (i.e., Q value is high) compared to the antenna formed of the first antenna element electrode of the antenna device illustrated in FIG. 2. Consequently, the efficiency of the antenna is low. In conclusion, an excellent radiation Q is obtained by centrally feeding the antenna element electrode 21 as illustrated in FIG. 2. In addition, the radiation Q of the antenna changes depending on the gap between the antenna element electrode and the ground electrode facing the antenna element electrode, and depending on the size of the antenna element electrode, and therefore selection may be made such that the radiation Q of the antenna depending on either of or a combination of these factors is excellent.

In an antenna device in which an antenna matching circuit is loaded as described in the above embodiments, the real capability of the radiation Q of the antenna is reflected in the efficiency of the antenna device and therefore the better the radiation Q of the antenna (the smaller the Q value) is, the higher the obtained efficiency characteristic is.

In the above-described examples, the antenna element electrode is arranged outside of the area of the substrate in which the ground electrode is formed, but the antenna element electrode may instead be arranged inside of the area of the substrate in which the ground electrode is formed. In addition, the antenna element electrode may be directly formed in a non-ground area of the substrate.

In the examples described above, the antenna element electrodes are described as having planar plate-like shapes, but may be patterned into any predetermined shape. In the frequency band used in sensing (since it's far from the frequency of wireless communication), even if patterned, a formed pattern serves as “a facing conductor” for a stray capacitance.

In addition, a plurality of antenna element electrodes may be provided in a single dielectric block.

Regarding patterning of an antenna element electrode, for example, a pattern may be formed that resonates at both a fundamental and a harmonic frequency by forming a slit or forming a branching shape; a pattern may be formed such that there is a resonant point in plurality of bands by inserting a reactance element into an antenna element electrode; and a pattern may be formed that branches to a feeder element and a passive element.

In addition, although the variable matching circuit has two sets of broad band resonance characteristics in two frequency bands that are targets of reconfigurement and adjusts matching in accordance with the surrounding environment, embodiments consistent with the present disclosure are not limited to this. For example, the present disclosure may be applied to:

(1) a circuit that has one set of resonance characteristics,

(2) a circuit that includes a variable reactance element in a π type or T type circuit configuration (reconfigurement is not considered), or

(3) a configuration in which a plurality of matching circuits are prepared in advance and the matching circuits are switched for path selection in accordance with the degree of nearness of a human body.

In addition, the targets of reconfigurement are not limited to cases of a low band (for example, 800/900 MHz GSM (Registered Trademark)) and a high band (for example, DCS, PCS and UMTS). Other systems (e.g., such as wireless LAN (WLAN), Bluetooth (Registered Trademark) and Wimax (Registered Trademark)) may also be covered and a case is also possible in which five bands (Pentaband) are covered with finer division (at such a time, the prepared capacitance values are finely set).

Antennas other than the main (cellular) antenna included in a portable terminal include for example an antenna that assists the main antenna for cellular use, an antenna for Bluetooth (Registered Trademark) or wireless LAN, a GPS antenna, an antenna for receiving digital TV, an antenna for near field communication (NFC) and an antenna for receiving FM. Integration of these antennas is difficult and they are provided as separate antennas. Stray capacitance detection may be performed using one or a plurality of separate antennas and the result of such detection may be supplied to variable matching circuit of another antenna or may be in addition supplied to the variable matching circuit of its own antenna.

In addition, an antenna element electrode used to perform variable matching or an antenna element electrode for stray capacitance detection may be an electrode for communication utilizing a human body. For example, embodiments consistent with the present disclosure can also be applied to an antenna for human body vicinity quasi-electrostatic field communication technology described in NTT Journal 2010.1 “human body vicinity electrostatic field communication technology ‘Red Tacton’ and applications thereof.”

Other than to a plurality of antenna element electrodes provided inside one casing within a portable terminal, the present disclosure can also be applied to antenna electrodes separately arranged in two casings within a clam shell type casing. In addition, other than the clam shell type casing, the present disclosure can also be similarly applied to sliding and swivel type portable terminals.

According to the above-described embodiments, for example, a capacitance-voltage conversion circuit may be added as an additional component to the antenna structure substantially without any modification of the antenna structure. The effect on the design of the structure of a portable terminal is small and the antenna structure can be easily adopted in a plurality of models.

In embodiments consistent with the present disclosure, not just at time of transmission, the antenna characteristics can be corrected by detecting the surrounding environment of the antenna and performing feedback. In addition, since a member other than the members that are needed for radiation is not required, the antenna characteristics are not degraded by such a member. In addition, since reflection of for example light, infrared rays, or sound waves is not utilized, a change in antenna characteristics can be accurately detected without there being limitations on detection direction and angle.

In embodiments in which the capacitance detection circuit is a capacitance-voltage conversion amplifier circuit that includes a feedback capacitance in a feedback circuit of an inverting amplifier circuit and outputs a voltage that is substantially proportional to a rate of change ratio of a detection target capacitance to the feedback capacitance, since a capacitance-voltage conversion circuit may be added as an additional component to an antenna device substantially without any modification of the antenna element electrode, there is little effect on the design of an electronic apparatus into which the antenna device is going to be incorporated and the antenna device can be easily applied to a plurality of models.

In embodiments including a reactance element (e.g., a capacitor) that hinders inflow of a sensing signal (e.g., exhibits a high impedance in sensing frequency band) along a wireless communication signal path, which is a transmission path for the second antenna element electrode, the sensing signal does not loop back into the wireless communication signal and the antenna characteristics are substantially not degraded.

In an embodiment in which a reactance element (inductor) that hinders looping back of a wireless communication signal fed to the second antenna element electrode or transmitted from the second antenna element electrode is provided along a sensing signal path, which is a transmission path between the second antenna element electrode and the capacitance detection circuit, the capacitance detection circuit does not affect the antenna element electrode in the communication signal frequency band and therefore the antenna characteristics are substantially not degraded.

In embodiments where among a plurality of types of antenna element electrodes that are capable of being connected to an antenna connection portion of the antenna matching circuit, the first antenna element electrode is an antenna element electrode that has a good radiation Q (i.e., low Q value) in an integrated body that includes the antenna element electrode, an antenna having a good radiation Q is connected to the antenna matching circuit and as a result an antenna device having high efficiency can be formed.

In an embodiment in which a selection condition for the plurality of types of antenna element electrodes is any of a position of a feeding point for the antenna element electrode, a gap between the antenna element electrode and an opposing ground, and the size of the antenna element electrode, or a combination of any of these, an antenna element electrode having a good radiation Q can be easily selected with certainty and an antenna device having high efficiency can be formed.

In disclosed embodiments of antenna device including a plurality of antenna element electrodes that are all fed by a feeder circuit (a matching circuit is included as needed), a capacitance detection circuit that is connected to the plurality of antenna element electrodes and detects a stray capacitance of each of the antenna element electrodes using a sensing signal, and a nearby body state detector configured to detect a state of nearness of a nearby body with respect to the plurality of antenna element electrodes on the basis of a detection signal of the capacitance detection circuit, capacitance detection employing a plurality of antenna element electrodes is performed, the plurality of antenna element electrodes serving as a single antenna element. Consequently, information on a body that is near to the antenna device can be detected in a plurality of dimensions. In addition, since a member other than the members that are needed for radiation is not required, the antenna characteristics are not degraded by such a member.

In disclosed embodiments of an antenna device including a plurality of antenna element electrodes that are all fed by a feeder circuit and a reactance element that hinders inflow of a sensing signal (exhibits a high impedance in sensing frequency band) is provided along a wireless communication signal path, which is a transmission path for the plurality of antenna element electrodes, the sensing signal does not loop back into the wireless communication signal and the antenna characteristics are substantially not degraded.

In embodiments of an antenna device including a plurality of antenna element electrodes that are all fed by a feeder circuit and a reactance element that hinders looping back of a wireless communication signal fed to the plurality of antenna element electrodes or transmitted from the plurality of antenna element electrodes is provided along a sensing signal path, which is a transmission path between the plurality of antenna element electrodes and the capacitance detection circuit, the capacitance detection circuit does not affect the antenna elements in the communication signal frequency band and therefore the antenna characteristics are substantially not degraded.

In embodiments of the Among a plurality of types of antenna element electrodes that are capable of being connected to an antenna connection portion of the antenna matching circuit, the plurality of antenna element electrodes are antenna element electrodes that have a good radiation Q (i.e., low Q value) in integrated bodies including the antenna element electrodes, an antenna having a good radiation Q is connected to the antenna matching circuit and as a result an antenna device having high efficiency can be formed.

In embodiments of an antenna device including a plurality of antenna element electrodes that are all fed by a feeder circuit where selection conditions for the plurality of types of antenna element electrodes include a position of a feeding point for the antenna element, and a position of connection of the capacitance detection circuit to the antenna element electrode, antenna element electrodes having a good radiation Q can be easily selected with certainty and an antenna device having high efficiency can be formed.

In embodiments in which the sensing signal is a signal having a frequency that is sufficiently lower than, that is, 1/1000 or less, the resonant frequency of the plurality of antenna element electrodes, a wireless communication signal path and a sensing signal path connected to the same antenna element electrode can coexist.

According to the present invention, antenna characteristics can be corrected not just at the time of transmission, by detecting the surrounding environment of the antenna and performing feedback. In addition, since a member other than the members that are needed for radiation is not required, the antenna characteristics are not degraded by such a member. In addition, since reflection of for example light, infrared rays, or sound waves is not utilized, a change in antenna characteristics can be accurately detected without there being limitations on detection direction and angle.

That which is claimed is:

1. An antenna device comprising:
a plurality of antenna element electrodes including at least a first antenna element electrode and a second antenna element electrode;
an antenna matching circuit provided along a wireless communication signal path for the first antenna element electrode;
a capacitance detection circuit connected to the second antenna element electrode and operable to detect a stray capacitance of the second antenna element electrode using a sensing signal and generate an output signal corresponding to detected stray capacitance; and
a matching control circuit operable to control the antenna matching circuit in accordance with the output signal of the capacitance detection circuit.

2. The antenna device according to claim 1, wherein the capacitance detection circuit is a capacitance-voltage conversion amplifier circuit that includes a feedback capacitance in a feedback circuit of an inverting amplifier circuit and outputs a voltage that is substantially proportional to a rate of change ratio of a detection target capacitance to the feedback capacitance.

3. The antenna device according to claim 1, wherein a reactance element that hinders inflow of a sensing signal is provided along a wireless communication signal path, which is a transmission path for the second antenna element electrode.

4. The antenna device according to claim 2, wherein a reactance element that hinders inflow of a sensing signal is provided along a wireless communication signal path, which is a transmission path for the second antenna element electrode.

5. The antenna device according to claim 1, wherein a reactance element that hinders looping back of a wireless communication signal fed to the second antenna element electrode or transmitted from the second antenna element electrode is provided along a sensing signal path, which is a transmission path between the second antenna element electrode and the capacitance detection circuit.

6. The antenna device according to claim 1, wherein, among a plurality of types of antenna element electrodes that are capable of being connected to an antenna connection portion of the antenna matching circuit, the first antenna element electrode is an antenna element electrode that has a lowest radiation Q value of the plurality of types in an integrated body that includes the antenna element electrode.

7. The antenna device according to claim 6, wherein a selection condition for the plurality of types of antenna element electrodes is any of a position of a feeding point for the antenna element electrode, a gap between the antenna element electrode and an opposing ground, and the size of the antenna element electrode, or any combination thereof.

8. The antenna device according to claim 1, wherein the sensing signal is a signal having a frequency that is 1/1000 or less lower than the resonant frequency of the plurality of antenna element electrodes.

9. The antenna device according to claim 9, wherein wireless communication signal paths for the first antenna element electrode and a sensing signal path for the second antenna element electrode are close to each other to such a degree that they can be regarded as being substantially one body when compared to wavelength.

10. The antenna device according to claim 9, wherein the first antenna element electrode is substantially centrally fed.

11. An antenna device comprising:
a plurality of antenna element electrodes that are all fed by a feeder circuit;
a capacitance detection circuit connected to the plurality of antenna element electrodes and operable to detect a stray capacitance of each of the antenna element electrodes using a sensing signal; and
a nearby body state detector operable to detect a state of nearness of a nearby body with respect to the plurality of antenna element electrodes on the basis of a detection signal of the capacitance detection circuit.

12. The antenna device according to claim 11, further comprising an antenna matching circuit provided along a wireless communication signal path for the plurality of antenna element electrodes, and
a matching control circuit that controls the antenna matching circuit in accordance with an output signal of the capacitance detection circuit.

13. The antenna device according to claim 11, wherein a reactance element that hinders inflow of the sensing signal is provided along a wireless communication signal path, which is a transmission path for the plurality of antenna element electrodes.

14. The antenna device according to claim 12, wherein a reactance element that hinders inflow of the sensing signal is provided along a wireless communication signal path, which is a transmission path for the plurality of antenna element electrodes.

15. The antenna device according to claim 11, wherein a reactance element that hinders looping back of a wireless communication signal fed to the plurality of antenna element electrodes or transmitted from the plurality of antenna element electrodes is provided along a sensing signal path, which is a transmission path between the plurality of antenna element electrodes and the capacitance detection circuit.

16. The antenna device according to claim 11, wherein, among a plurality of types of antenna element electrodes that are capable of being connected to an antenna connection portion of the antenna matching circuit, the plurality of antenna element electrodes are antenna element electrodes that have a lowest radiation Q value among the plurality of types of antenna element electrodes in integrated bodies including the antenna element electrodes.

17. The antenna device according to claim 14, wherein selection conditions for the plurality of types of antenna element electrodes include a position of a feeding point for the antenna element electrodes, and a position of connection of the capacitance detection circuit to the antenna element electrodes.

18. The antenna device according to claim 11, wherein the sensing signal is a signal having a frequency that is 1/1000 or less lower than the resonant frequency of the plurality of antenna element electrodes.

19. The antenna device according to claim 11, wherein wireless communication signal paths for the plurality of antenna element electrodes and sensing signal paths for the plurality of antenna element electrodes are close to each other to such a degree that they can be regarded as being substantially one body when compared to wavelength.

20. The antenna device according to claim 11, wherein at least one of the plurality of antenna element electrodes is substantially centrally fed.
